(19) United States
(12) Patent Application Publication
(10) Pub. No.: US 2024/0344368 A1
(43) Pub. Date: Oct. 17, 2024

(54) BICYCLE LOCK

(71) Applicant: CARLOS AGUIRRE, FLOWER MOUND, TX (US)

(72) Inventor: CARLOS AGUIRRE, FLOWER MOUND, TX (US)

(73) Assignee: CARLOS AGUIRRE, FLOWER MOUND, TX (US)

(21) Appl. No.: 18/134,608

(22) Filed: Apr. 14, 2023

(51) Int. Cl. E05B 71/00

(52) U.S. Cl. CPC E05B 71/00

(57) ABSTRACT

Disclosed is a bicycle lock for use with a pick-up truck bed. The bicycle lock includes a body member crossbar; and a ratchet system. The ratchet system includes a reversible pawl; a hoop; a handle; and an extendable lock. The body member crossbar is tubular in shape and expandable in size through the ratchet system to fit various sizes of the widths of the pick-up truck bed, wherein the reversible pawl is pivotally engaging the internal teeth defined in the ratchet system. The extendable lock extends from 40″-70″ inches and mounts across the pick-up truck bed to secure one or more bicycles. The body member crossbar is secured on at least two cargo hooks of the pick-up truck bed and secured by a padlock from the handle to the hoop attached to a bar lock of the body member crossbar.

### TECHNICAL FIELD

This invention relates, generally, to a device for securing and carrying bicycles on a pick-up truck and, more particularly, to a bicycle lock for use with a pick-up truck bed.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Vehicles including cars, pickup trucks, and trailers are frequently used to transport bicycles. To secure these bicycles while being transported, numerous racks and tie-down systems have been developed. Currently, these bicycles must be clamped, strapped, or partially disassembled before they may be transported using the existing solutions. It takes a lot of time and effort to load, unload, and lock/unlock bicycles and other equipment when using the existing solutions. Further, the existing solutions do not have aesthetics and do not provide functional solutions for people to safely transport and keep their bicycles in a vehicle.

Thus, in view of the above, there is a long-felt need in the industry to address these deficiencies and inadequacies. This specification recognizes that there is a necessity for an efficient and improved bicycle lock to safely carry the bicycles in a pick-up truck bed.

Further limitations and disadvantages of conventional approaches will become apparent to one of ordinary skill in the art through the comparison of described systems with some aspects of the present disclosure, as set forth in the remainder of the present application and with reference to the drawings.

### SUMMARY

A bicycle lock for use with a pick-up truck bed is provided substantially, as shown in and/or described in connection with at least one of the figures.

An aspect of the present disclosure relates to a bicycle lock for use with a pick-up truck bed. The bicycle lock includes a body member crossbar; and a ratchet system. The ratchet system includes a reversible pawl; a hoop; a handle; and an extendable lock. The body member crossbar is tubular in shape and expandable in size through the ratchet system to fit various sizes of the widths of the pick-up truck bed, wherein the reversible pawl is pivotally engaging the internal teeth defined in the ratchet system. The extendable lock extends from 40″-70″ inches and mounts across the pick-up truck bed to secure one or more bicycles. The body member crossbar is secured on at least two cargo hooks of the pick-up truck bed and secured by a padlock from the handle to the hoop attached to a bar lock of the body member crossbar.

In an aspect, the bicycle lock includes an inner tube; a hollow outer tube; and a plurality of hinges. The hollow outer tube houses the inner tube; a plurality of nuts and bolts to secure the ratchet system to the hollow outer tube. The hinges attach the hollow outer tube to the inner tube.

In an aspect, the inner tube stretches up to 70 inches and retracts up to 40 inches to tighten up a plurality of chains with a plurality of cargo hooks into a plurality of cargo hoops.

In an aspect, the ratchet system includes either an external padlock or a built-in locking system. Either the external padlock mounts over the ratchet handle through the cargo hoops or the built-in locking system within the ratchet system or attached to the ratchet system. The built-in locking system secures the ratchet handle so it does not release and be removed.

In an aspect, the ratchet system includes a wheel; a link; a fixed guide; a torsion spring; and a fixed axis.

In an aspect, the wheel contains the teeth on which the groves of the inner tube latchets and guides the retraction of the inner tube.

In an aspect, the link determines the direction in which the ratchet system retracts or expands.

In an aspect, the fixed guide holds or latches into the teeth of the wheel to retract or expand.

In an aspect, the torsion spring exerts a torque or rotary force.

In an aspect, the fixed axis holds the wheel in place while the wheel rotates.

In an aspect, the pick-up truck bed is made of steel.

In an aspect, the inner tube includes grooves that are strip-shaped.

Accordingly, one advantage of the present invention is that bicycles can be safely kept and easily transported in a vehicle.

Other features of embodiments of the present invention will be apparent from the accompanying drawings and from the detailed description that follows.

Yet other objects and advantages of the present invention will become readily apparent to those skilled in the art following the detailed description, wherein the preferred embodiments of the invention are shown and described, simply by way of illustration of the best mode contemplated herein for carrying out the invention. As we realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates an assembled view of various components of a bicycle lock for use with a pick-up truck bed, in accordance with a preferred embodiment of the present disclosure;

FIG. 2 illustrates a perspective view of a ratchet system, in accordance with a preferred embodiment of the present disclosure;

FIGS. 3A-3B illustrate a perspective view of a padlock, in accordance with a preferred embodiment of the present disclosure;

FIGS. 4-5 illustrate exploded views of the bicycle lock for use with a pick-up truck bed, in accordance with a preferred embodiment of the present disclosure;

FIG. 6 illustrates a perspective view of an external padlock, in accordance with a preferred embodiment of the present disclosure; and

FIG. 7 illustrates a perspective view of a built-in locking system, in accordance with a preferred embodiment of the present disclosure.

### DETAILED DESCRIPTION

The present invention is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

While, for purposes of simplicity of explanation, the methodology is shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter.

It must also be noted that, as used in this specification and the appended claims, the singular forms “a,” “an” and “the” include plural referents unless the context dictates otherwise.

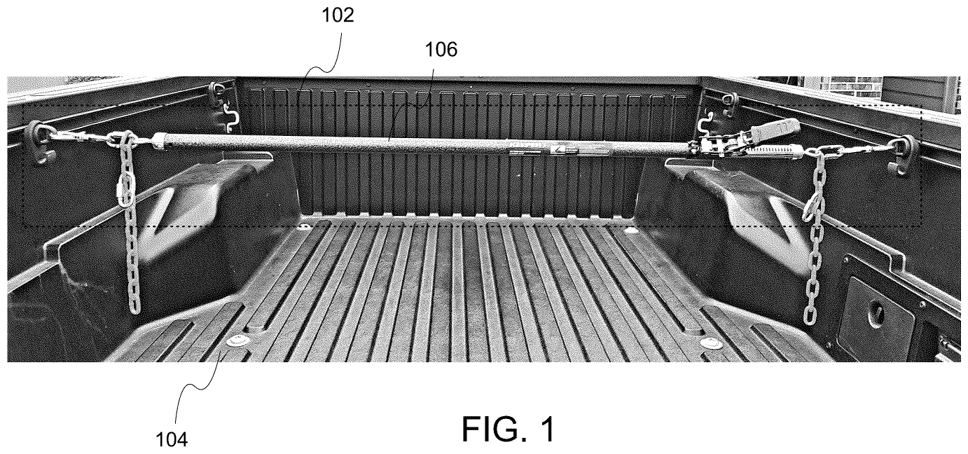

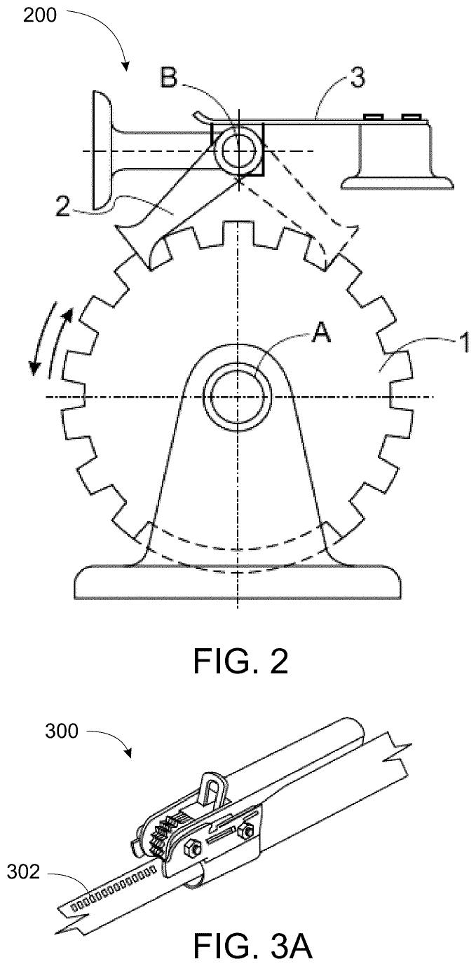

FIG. 1 illustrates an assembled view of various components of a bicycle lock (102) for use with a pick-up truck bed (104), in accordance with a preferred embodiment of the present disclosure. In an embodiment, the bicycle lock (102) of the present invention can be integrated with a full or a mid-size truck bed that is made of steel. In an embodiment, the bicycle lock (102) has a body member cross bar that is tubular in shape and expandable in size through a ratchet mechanism to fit different truck's bed widths. The ratchetable/extendable lock extends from 40″ to 70″ inches and mounts across the bed securing bicycles. The bicycle lock (102) is secured on the cargo hooks of the truck bed and secured by a padlock from the ratchet handle loop to a secured loop permanently attached to the tubular expandable bar lock. Thus, the present disclosure describes a bicycle lock that includes a body member crossbar (106); and a ratchet system 200 (shown and explained in conjunction with FIG. 2). The body member crossbar (106) is tubular in shape and expandable in size through the ratchet system (200) is operable to fit various sizes of the widths of the pick-up truck bed. In an embodiment, the pick-up truck bed is made of steel.

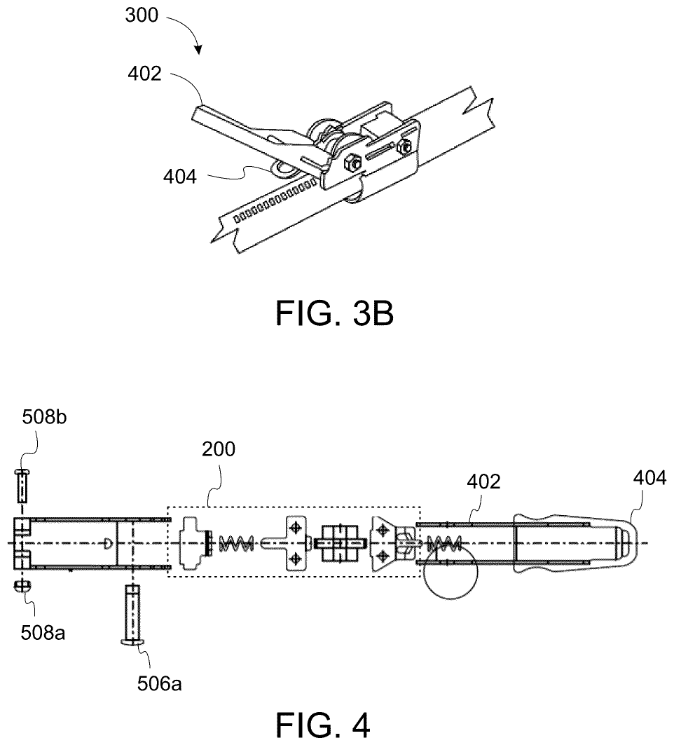

FIG. 2 illustrates a perspective view of a ratchet system (200), in accordance with a preferred embodiment of the present disclosure. The ratchet system (200) includes a reversible pawl (2); a hoop; a handle 402 (shown in FIG. 3B); an extendable lock; a wheel (1); a link (3); a torsion spring; and a fixed axis (A); and a fixed guide (B).

The link (3) determines the direction in which the ratchet system (200) retracts or expands. The fixed guide (B) holds or latches into the teeth of the wheel (1) to retract or expand. The torsion spring exerts a torque or rotary force. The fixed axis (A) holds the wheel (1) in place while the wheel (1) rotates. The fixed axis (A) rotates and drives the rack inward or outward. The reversible pawl (2) is pivotally engaging the internal teeth defined in the ratchet system (200). The extendable lock extends from 40″-70″ inches and mounts across the pick-up truck bed (104) to secure one or more bicycles.

FIGS. 3A-3B illustrate a perspective view of a padlock (300), in accordance with a preferred embodiment of the present disclosure. FIGS. 3A-3B explained in conjunction with FIGS. 1-2. The body member crossbar (106) is secured on at least two cargo hooks of the pick-up truck bed and secured by the padlock (300) from the handle (402) to the hoop attached to a bar lock of the body member crossbar (106). The wheel (1) contains the teeth (302) on which the groves of the inner tube latchet and guides the retraction of the inner tube. The bicycle lock (102) is secured on the cargo hooks of the truck bed and secured by the padlock from the ratchet handle loop to the secured loop (404) permanently attached to the body member crossbar (106).

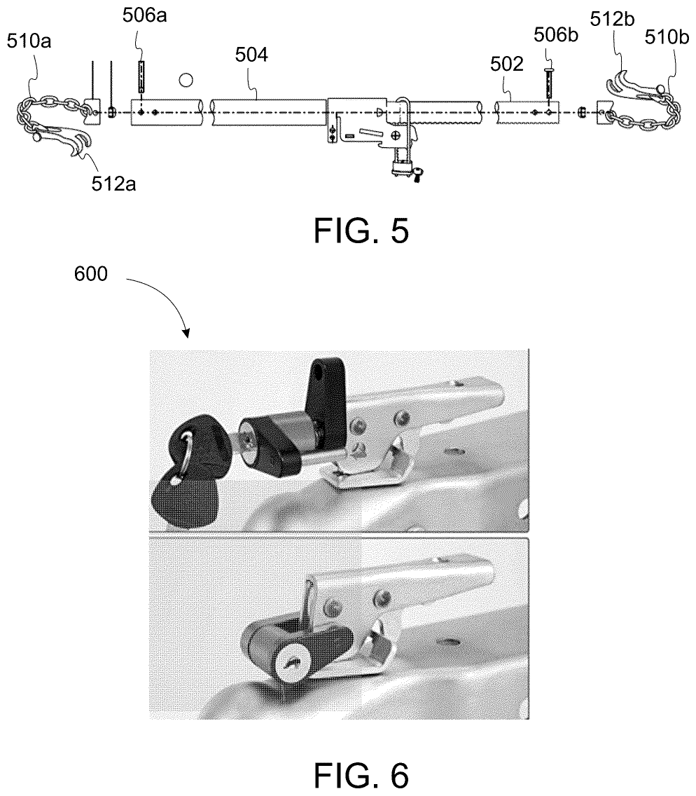

FIGS. 4-5 illustrate exploded views of the bicycle lock for use with a pick-up truck bed, in accordance with a preferred embodiment of the present disclosure. FIGS. 4-5 explained in conjunction with FIG. 1-FIG. 3B. The bicycle lock (102) includes an inner tube (502); a hollow outer tube (504); and a plurality of hinges (506a, and 506b). In an aspect, the inner tube (502) includes grooves that are strip-shaped. The hollow outer tube (504) houses the inner tube (502); a plurality of nuts and bolts (508a, and 508b) to secure the ratchet system (200) to the hollow outer tube. The hinges (506a, and 506b) attach the hollow outer tube (504) to the inner tube (502). In an embodiment, the inner tube (502) stretches up to 74 inches and retracts up to 40 inches to tighten up a plurality of chains (510a, and 510b) with a plurality of cargo hooks (512a, and 512b) into a plurality of cargo hoops.

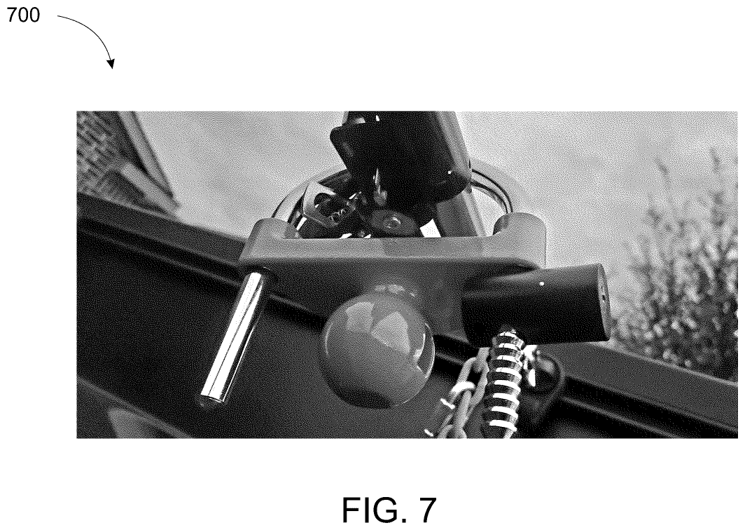

FIG. 6 illustrates a perspective view of an external padlock (600), in accordance with a preferred embodiment of the present disclosure. FIG. 7 illustrates a perspective view of a built-in locking system (700), in accordance with a preferred embodiment of the present disclosure. FIGS. 6-7 explained in conjunction with FIG. 1-FIG. 5. The ratchet system (200) includes either an external padlock (600) or a built-in locking system (700). Either the external padlock (600) mounts over the handle (402) through the cargo hoops or the built-in locking system (700) within the ratchet system (200) or attached to the ratchet system (200). The built-in locking system (700) secures the handle (402) so it does not release and be removed. In an embodiment, the external padlock (600) acts as a coupler-type lock that presses the handle bar down to keep it immobilized so it does not release the tension, thus keeping the body member crossbar secure. Further, the built-in locking system (700) is integrated within the ratchet system (700) or can be implemented on the exterior, thus immobilizing the handle bar from moving back and forth, hence preventing the release of tension that keeps the ratchet locked.

Throughout the specifications of the present disclosure, the term “comprising” means including but not necessarily to the exclusion of other elements or steps. In other words, the term comprising indicates an open list. Furthermore, all directional references (such as but not limited to, upper, lower, inner, outer, upward, downward, inwards, outwards, right, left, rightward, leftward, inside, outside, top, bottom, above, below, vertical, horizontal, clockwise, and counter-clockwise, lineal, axial and/or radial, or any other directional and/or similar references) are only used for identification purposes to aid the reader's understanding of illustrative embodiments of the present disclosure, and may not create any limitations, particularly as to the position, orientation, or use unless specifically set forth in the claims. Moreover, all directional references are approximate and should not be interpreted as exact, but rather as describing a general indicator as to an approximate attitude.

Similarly, joinder references (such as but not limited to, attached, coupled, connected, accommodated, and the like and their derivatives) are to be construed broadly and may include intermediate members between a connection of segments and relative movement between segments. As such, joinder references may not necessarily infer that two segments are directly connected and in fixed relation to each other.

In some instances, components are described with reference to “ends” having a particular characteristic and/or being connected with another part. However, those skilled in the art will recognize that the present disclosure is not limited to components that terminate immediately beyond their points of connection with other parts. Thus, the term “end” should be interpreted broadly, in a manner that includes areas adjacent, rearward, forward of, or otherwise near the terminus of a particular segment, link, component, part, member, or the like. Additionally, all numerical terms, such as but not limited to, “second”, “second”, “third”, “fourth”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

As will be readily apparent to those skilled in the art, the present invention may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein. Many variations, modifications, additions, and improvements are possible. More generally, embodiments in accordance with the present disclosure have been described in the context of preferred embodiments. Functionalities may be separated or combined in procedures differently in various embodiments of the disclosure or described with different terminology. These and other variations, modifications, additions, and improvements may fall within the scope of the disclosure as defined in the appended claims.

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claims.

I/we claim:

1. A bicycle lock for use with a pick-up truck bed, said bicycle lock comprising:
a body member crossbar; and
a ratchet system, comprising:
a reversible pawl;
a hoop;
a handle; and
an extendable lock, wherein the body member crossbar is tubular in shape and expandable in size through the ratchet system to fit various sizes of the widths of the pick-up truck bed, wherein the reversible pawl is pivotally engaging the internal teeth defined in the ratchet system, wherein the extendable lock extends from 40″-70″ inches and mounts across the pick-up truck bed to secure one or more bicycles, wherein the body member crossbar is secured on at least two cargo hooks of the pick-up truck bed and secured by a padlock from the handle to the hoop attached to a bar lock of the body member crossbar.

2. The bicycle lock as claimed in claim 1 comprises:
an inner tube;
a hollow outer tube to house the inner tube;
a plurality of nuts and bolts to secure the ratchet system to the hollow outer tube; and
a plurality of hinges to attach the hollow outer tube to the inner tube.

3. The bicycle lock as claimed in claim 2, wherein the inner tube stretches up to 70 inches and retracts up to 40 inches to tighten up a plurality of chains with a plurality of cargo books into a plurality of cargo hoops.

4. The bicycle lock as claimed in claim 1, wherein the ratchet system comprises one or more of an external padlock or a built-in locking system.

5. The bicycle lock as claimed in claim 1, wherein the ratchet system comprises a wheel; a link; a fixed guide; a torsion spring; and a fixed axis.

6. The bicycle lock as claimed in claim 5, wherein the wheel contains the teeth on which the groves of the inner tube latchets and guides the retraction of the inner tube.

7. The bicycle lock as claimed in claim 5, wherein the link determines the direction in which the ratchet system retracts or expands.

8. The bicycle lock as claimed in claim 5, wherein the fixed guide holds or latches into the teeth of the wheel to retract or expand.

9. The bicycle lock as claimed in claim 5, wherein the torsion spring exerts a torque or rotary force.

10. The bicycle lock as claimed in claim 5, wherein the fixed axis holds the wheel in place while the wheel rotates.

11. The bicycle lock as claimed in claim 1, wherein the pick-up truck bed is made of steel.

12. The bicycle lock as claimed in claim 2, wherein the inner tube includes grooves that are strip-shaped.
